(19) United States
(12) Patent Application Publication
(10) Pub. No.: US 2009/0068926 A1
(43) Pub. Date: Mar. 12, 2009

(54) Assembly for capturing bees

(76) Inventor: Joseph M. Venglar, Boling, TX (US)

Correspondence Address: LOREN G. HELMREICH, 5851 San Felipe, SUITE 975, HOUSTON, TX, 77057, US

(21) Appl. No.: 11/900,160

(22) Filed: Sep. 11, 2007

(51) Int. Cl. A01K 47/06; A01K 47/00

(52) U.S. Cl. 449/6; 449/15; 449/20; 449/3

(57) ABSTRACT

An assembly 10 for capturing bees comprises a bee hive defining a hive chamber 14 housing a plurality of comb frames 16, and a bee access opening 18 to the bee hive. The assembly includes a collection enclosure 30 defining a collection chamber 32 in fluid communication with the hive chamber, and one or more dividers 38 separating the collection chamber from a restricted chamber. Each of the dividers 38 include a plurality of fluid passageways 40. The assembly further includes a powered vacuum unit 44 for drawing air and bees through the suction opening.

### FIELD OF THE INVENTION

The present invention relates to equipment and techniques for capturing insects. More particularly, this invention relates to devices for capturing live bees while minimizing the damage to the captured bees.

### BACKGROUND OF THE INVENTION

Various types of equipment have been devised for capturing insects. U.S. Pat. No. 4,631,858 discloses a piston-type device which creates a suction to catch a bug. U.S. Pat. No. 4,817,330 discloses an insect capturing device with a bellows to create a vacuum when squeezed. U.S. Pat. No. 4,979,330 discloses an electric insect trapping device having a vacuum pump. U.S. Pat. No. 5,052,147 discloses a hand-held, battery powered device for collecting and disposing of insects. U.S. Pat. No. 5,367,821 discloses another variation of a suction insect trap. U.S. Pat. No. 5,915,950 discloses a suction device particularly suited for flies and roaches. U.S. Pat. No. 6,226,919 discloses an insect vacuum trap with a centrifugal impeller. U.S. Pat. No. 7,152,368 teaches another hand-held device for capturing insects. For most if not all of the above devices, the insect is undesirable, and is frequently injured or killed during the trapping process, or is captured in a manner wherein the insect will subsequently be killed.

Bees are one type of insect recognized to have advantageous qualities. Bees provide tremendous assistance in pollinating plants which provide fruits, and provide honey and other useful products. U.S. Pat. No. 1,982,418 teaches a queen bee excluder. U.S. Pat. No. 2,829,384 teaches a bee swarm collector. The construction of the device suggest a high probability of injuring many bees, and the remaining live bees within the device are transported to another location before entering a conventional box-type hive. U.S. Pat. No. 4,288,880 discloses another type of bee vacuum device for removing bees from a comb. Another type of bee collection device is known as the Honeybee Vacuum is available from Walter T. Kelley Company.

The above prior art does not provide a mobile system for easily collecting bees from undesirable locations, collecting and briefly housing the bees in a chamber with minimal injury to the bees, and capturing bees in a manner which increases the tendency of bees to enter a conventional box-type hive such that the collection device may thereafter be reused.

The disadvantages of the prior art are overcome by the present invention, and an improved assembly and technique for capturing bees is provided.

### SUMMARY OF THE INVENTION

In one embodiment, an assembly for capturing bees includes a bee hive enclosure defining a hive chamber housing a plurality of comb frames, and the access opening to the hive chamber. The assembly also includes a collection enclosure defining a collection chamber in fluid communication with the hive chamber to provide a bee access opening, and a suction opening through the collection enclosure for passing bees into the collection chamber. The collection enclosure further includes a discharge opening through the collection device, and one or more dividers separating the collection chamber from a restricted chamber within the collection enclosure. Each of the one or more dividers includes a plurality of fluid passageways for passing air to and filtering bees from the restricted chamber, and the discharge opening is in fluid communication with the restricted chamber. The assembly further includes a powered vacuum unit for drawing air and bees through the suction opening, drawing air into the restricted chamber, and discharging air from the discharge opening.

A significant feature of the invention is that the assembly for capturing bees is highly portable, and a hose from the suction device can enter confined spaces. A significant feature of the invention is that the vacuum powered device is constructed in a manner which minimizes injury to the bees. Yet a further feature of the invention is that the bees may promptly exit the collection device and move to the bee hive enclosure.

These and further features and advantages of the present invention will become apparent from the following detailed description, wherein reference is made to the figures in the accompanying drawings.

### BRIEF DESCRIPTION OF THE DRAWINGS

FIG. 1 is a pictorial view of one embodiment of a device for capturing bees.

FIG. 2 illustrates the device as shown in FIG. 1, with the vacuum unit, the suction hose, and the transparent plate over the combs removed.

FIG. 3 is a cross-sectional view of the assembly as shown in FIG. 1.

FIG. 4 is a pictorial view of an alternate embodiment of the invention.

FIG. 5 is a side view of the embodiment shown in FIG. 4.

### DETAILED DESCRIPTION OF PREFERRED EMBODIMENTS

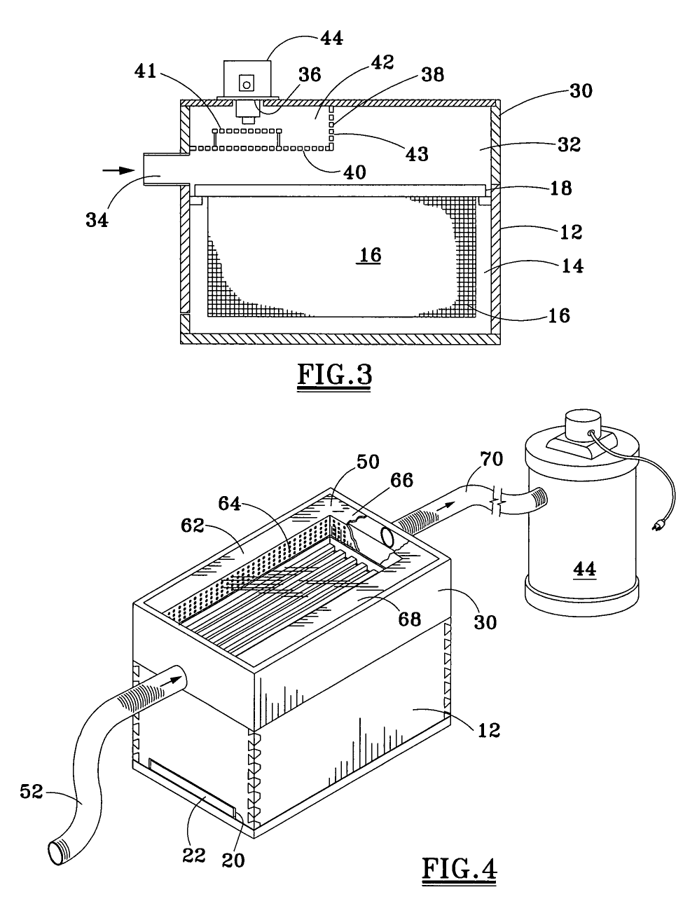

Referring now to FIG. 1, one embodiment of assembly 10 for capturing live bees includes a bee hive enclosure 12 and a collection enclosure 30. Bee hive enclosure 12 may be of the standard type, with the hive chamber 14 therein as shown in FIG. 3 housing a plurality of comb frames 16. Enclosure 12 further includes a bee access opening, which is the open top of the bee hive enclosure. The bee hive enclosure 12 includes substantially planar sides forming a rectilinear cross-sectional configuration, and a conventional floor 24. The rectilinear bee ingress and egress opening 20 is provided in the bee hive enclosure as shown in FIG. 1, and a similarly shaped plug 22 selectively closes off the ingress and egress opening.

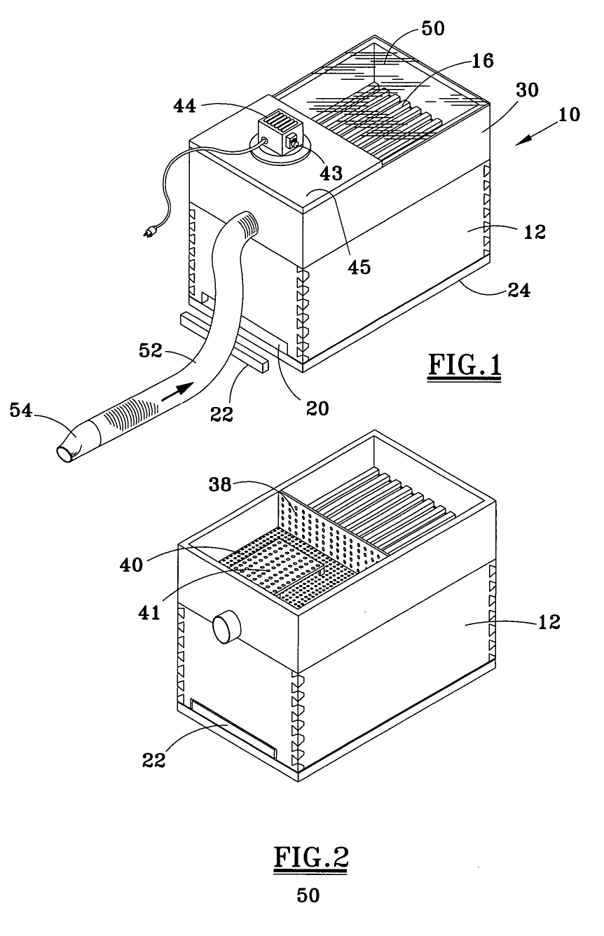

Still referring to FIG. 1, the collection enclosure 30 similarly has a substantially rectilinear configuration which defines a collection chamber 32 therein, as shown in FIG. 3. This chamber is in fluid communication with the hive chamber via the bee access opening 18 discussed above. A suction opening 34 through the collection enclosure is provided for passing bees into the collection chamber 32, while a discharge opening 36 through the collection enclosure discharges air from the collection enclosure. One or more dividers 38, 40 as shown in FIGS. 2 and 3 may be provided for separating the collection chamber 32 from the restricted chamber 42 within the collection enclosure, with the restricted chamber being blocked to access by bees. Each of the one or more dividers thus include a plurality of fluid passageways 43 for passing air from a collection chamber to the restricted chamber, while filtering bees from the restricted chamber. As shown in FIG. 3, the discharge open 36 is in fluid communication with the restricted chamber 42. A secondary divider 41 may be provided above the floor divider 40, and acts to further divert air as it enters the opening 36 to be discharged by the powered vacuum unit 44. FIG. 1 illustrates that the powered vacuum unit 44 may be electrically powered, but a suitable vacuum unit may be powered by any convenient source. A variable speed controller 43 is preferably provided for selectively adjusting the speed of the blower motor in the powered vacuum unit. A suction hose 52 connects the inlet opening 34 to a suction end of the hose, which as shown in FIG. 1 contains a nozzle 54 configured for capturing bees. FIG. 1 illustrates a wooden cover 45 on top of a portion of the collection enclosure and supporting the powered vacuum unit 44. At least a portion of the cover portion 50 of the collection enclosure is made from plexiglass or other transparent material, so that one may view the bees in the collection chamber and their migration into the bee hive enclosure and between the plurality of comb frames 16.

When gathering bees, the ingress and egress opening 20 is normally plugged by the plug 22, as shown in FIG. 2. The top cover and the powered vacuum unit have been removed in FIG. 2 to more clearly indicate the substantially vertical divider 38, the floor divider 40, and the raised floor or secondary divider 41.

Referring now to FIG. 3, the collection enclosure 30 is sitting on top of the bee hive enclosure, so that live bees may be drawn into the collection chamber 32, but are prevented from entering the restricted chamber 42. Air is drawn out the discharge opening 36 in the collection enclosure, thus drawing air out of the restricted chamber 42 and out of the collection chamber 32. The frame of enclosure 30 is substantially sealed to the frame of enclosure 12, so that little air is drawn into the enclosure that does not enter at port 34.

For the embodiment as shown in FIGS. 1-3, the collection enclosure thus has four sides and a top, and the discharge opening 36 passes through the top. The powered vacuum unit is mounted on the top for drawing air through the discharge opening. The bottom opening in the collection chamber thus substantially corresponds with the access opening in the top of the bee hive enclosure. The collection enclosure is removable from the bee hive enclosure, so that the collection enclosure may be removed from the bee hive enclosure 12 and a conventional cover placed on top of the bee hive enclosure. The collection enclosure may then be used with another conventional bee hive enclosure to collect bees at another site.

FIG. 4 depicts another embodiment of the invention, wherein the bee hive enclosure 12 is substantially as discussed above. In the FIG. 4 embodiment, the collection enclosure 30 similarly has a substantially rectilinear cross sectional configuration, although in this case some or all of the cover 50 is transparent. One or more dividers 64 with ports to filter bees are preferably provided on opposing sides of the collection enclosure, with each divider being a portion of an air plenum 62, 68 in fluid communication with the discharge opening through the connecting plenum 66, which may include similar holes for drawing air into the plenum while restricting access to the restricted chamber inside the plenum. For this embodiment, it is advantageous that air be drawn from the enclosure 30 at a position substantially opposite the intake of air into the enclosure through the flexible hose 52. Also, providing a pair of plenums on the sides of the enclosure provides a significantly large area to draw air into the plenums, with no significantly increased air flow velocity “pockets” within the enclosure. The “balanced system” thus has a discharge centerline equally between the long side plenums. Air within a central region in the top of the collection enclosure is thus drawn into the plenum and discharged from the device, while bees are retained in the collection chamber and are free to migrate downward into the bee hive enclosure 12. The FIG. 4 device illustrates a conventional vacuum unit 44 which is separate from the enclosure 30, and is connected thereto by the flexible line 70. A conventional shop vacuum may be used for the vacuum unit 44.

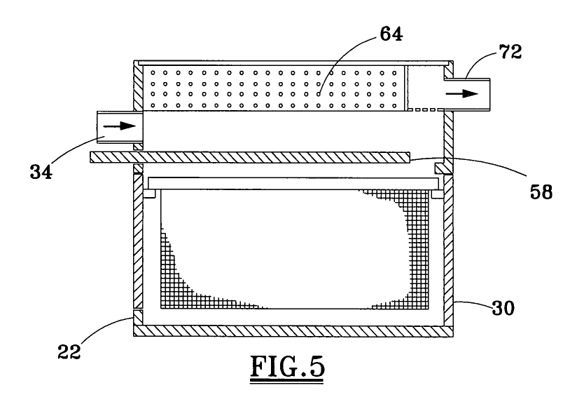

FIG. 5 is a cross section of the embodiment shown in FIG. 4, and illustrates the restricted chamber 74 formed by the plenum and the small diameter holes in the dividers. Those skilled in the art will appreciate that, for each of the embodiments disclosed herein, round holes may be provided in the dividers, while in other embodiments small diameter holes of other configurations, including elongate slits, may be provided for serving the same purpose of allowing air to enter the restricted chamber without a significant pressure drop, while filtering bees from the restricted chamber.

FIG. 5 illustrates the collection chamber 30 positioned immediately above but not yet engaging the bee hive. A floor 58 may be provided in a lower portion of the collection chamber in the event that it is not practical for bees to enter the collection chamber when positioned on the hive enclosure so that bees may immediately proceed downward into the bee hive enclosure. Bees may thus be collected in the collection chamber, and the collection chamber thereafter positioned above a conventional bee hive enclosure, which preferably is at the site where the bees are collected. During this brief transport, the floor 58 substantially closes off the interior of the collection chamber so that the bees do not escape. Once positioned on top of the bee hive enclosure 12, the floor 58 may be withdrawn, so that the lower opening in the collection enclosure is in direct fluid communication with the upper opening in the bee hive enclosure, thereby allowing bees to enter the enclosure.

In some cases, not all bees will be captured. For those embodiments, the assembly as disclosed herein may be retained near the site where the bees are collected, and toward evening the plug 22 may be removed thereby allowing bees to freely exit the bee hive enclosure. In substantially all cases, the bees will return before nighttime and reenter the bee hive enclosure. Most importantly, the bees which were not captured will similarly tend to pass through the opening 20 and will house within the bee hive enclosure for the evening. The user may thus insert the plug 22 in the morning, and at that stage, substantially all the bees should be within the bee hive enclosure. The user may thus simply lift the collection enclosure off the bee hive enclosure, put a conventional cover on the bee hive enclosure, then transmit the bee hive enclosure to a desired location where the bees may flourish. The collection enclosure 32 may then be reused with another conventional bee hive enclosure.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. An assembly for capturing bees, comprising:
a bee hive enclosure defining a hive chamber housing a plurality of comb frames, and a bee access opening to the hive chamber;
a collection enclosure defining a collection chamber in fluid communication with the hive chamber via the bee access opening, a suction opening through the collection enclosure for passing bees into the collection chamber, a discharge opening through the collection enclosure, and one or more dividers separating the collection chamber from a restricted chamber within the collection enclosure, each of the one or more dividers including a plurality of fluid passageways for passing air and filtering bees from the restricted chamber, the discharge opening being in fluid communication with the restricted chamber; and
a powered vacuum unit for drawing air and bees through the suction opening, drawing air into the restricted chamber, and discharging air from the discharge opening.

2. An assembly as defined in claim 1, wherein each of the one or more dividers includes a floor divider spaced above the suction opening and a side divider separating the restricted chamber from an upper portion of the collection chamber.

3. An assembly as defined in claim 1, wherein the one or more dividers includes a first divider adjacent a side of the collection enclosure, and a second divider adjacent an opposing side of the collection enclosure, each divider being a portion of an air plenum in fluid communication with the discharge opening.

4. An assembly as defined in claim 1, wherein the plurality of fluid passageways include through ports in the one or more dividers sized to filter bees from the restricted chamber.

5. An assembly as defined in claim 1, wherein the collection enclosure includes four sides and a top, at least a portion of the top being transparent such that bees within the collection chamber can be viewed.

6. An assembly as defined in claim 1, wherein the collection enclosure includes four sides and a top, the discharge opening passing through the top, and the powered vacuum unit being mounted for drawing air through the discharge opening.

7. An assembly as defined in claim 1, wherein the collection enclosure includes four sides and a top, the discharge opening passing through one of the four sides, the powered vacuum unit is structurally separate from the collection enclosure, and a hose interconnects the powered vacuum unit and the discharge opening.

8. An assembly as defined in claim 1, wherein the collection enclosure has a horizontal generally rectangular cross-sectional configuration, and a bottom opening in the collection chamber substantially corresponds with the access opening in the bee hive enclosure.

9. An assembly as defined in claim 1, further comprising:
a bee ingress and egress opening in the bee hive enclosure; and
a plug for selectively closing off the bee ingress and egress opening.

10. An assembly as defined in claim 1, further comprising:
a vacuum hose having a discharge end interconnected with the suction opening; and
a nozzle at an opposing entrance end of the vacuum hose.

11. An assembly as defined in claim 1, wherein the collection enclosure is removable from the bee hive enclosure, such that the collection enclosure may be removed from the bee hive enclosure and a cover placed on top of the bee hive enclosure.

12. An assembly as defined in claim 1, wherein the collection enclosure includes a removable floor, the floor substantially enclosing the collection chamber, the floor removed when positioning the collection enclosure on top of the bee hive enclosure.

13. An assembly for capturing bees, comprising:
a bee hive enclosure defining a hive chamber housing a plurality of comb frames, and a bee access opening to the hive chamber;
a collection enclosure defining a collection chamber in fluid communication with the hive chamber via the bee access opening, a suction opening through the collection enclosure for passing bees into the collection chamber, a discharge opening through the collection enclosure, and a plurality of dividers separating the collection chamber from a restricted chamber within the collection enclosure, the plurality of dividers including a floor divider spaced above the suction opening and a side divider separating the restricted chamber from an upper portion of the collection chamber, each of the plurality of dividers including a plurality of throughports for passing air and sized to filter bees from the restricted chamber, the discharge opening being in fluid communication with the restricted chamber, the collection enclosure being removable from the bee hive enclosure, such that the collection enclosure may be removed from the bee hive enclosure and a cover placed on top of the bee hive enclosure; and
a powered vacuum unit for drawing air and bees through the suction opening, drawing air into the restricted chamber, and discharging air from the discharge opening.

14. An assembly as defined in claim 13, wherein the collection enclosure includes four sides and a top, the discharge opening passing through the top, and the powered vacuum unit being mounted for drawing air through the discharge opening.

15. An assembly as defined in claim 13, wherein the collection enclosure includes four sides and a top, the top having at least a portion which is transparent such that bees within the collection chamber can be viewed.

16. An assembly as defined in claim 13, wherein the collection enclosure has a horizontal generally rectangular cross-sectional configuration, and a bottom opening in the collection chamber substantially corresponds with the access opening in the bee hive enclosure.

17. An assembly for capturing bees, comprising:
a bee hive enclosure defining a hive chamber housing a plurality of comb frames, and a bee access opening to the hive chamber;
a collection enclosure defining a collection chamber in fluid communication with the hive chamber via the bee access opening, a suction opening through the collection enclosure for passing bees into the collection chamber, a discharge opening through the collection enclosure, and a plurality of dividers separating the collection chamber from a restricted chamber within the collection enclosure, including a first divider adjacent a side of the collection enclosure, and a second divider adjacent an opposing side of the collection enclosure, each divider being a portion of an air plenum in fluid communication with the discharge opening, each of the one or more dividers including a plurality of fluid passageways for passing air and sized to filter bees from the restricted chamber, the discharge opening being in fluid communication with the restricted chamber, the collection enclosure being removable from the bee hive enclosure, such that the collection enclosure may be removed from the bee hive enclosure and a cover placed on top of the bee hive enclosure; and
a powered vacuum unit for drawing air and bees through the suction opening, drawing air into the restricted chamber, and discharging air from the discharge opening.

18. An assembly as defined in claim 17, wherein the collection enclosure includes four sides and a top, the discharge opening passing through the top, and the powered vacuum unit being mounted for drawing air through the discharge opening.

19. An assembly as defined in claim 17, wherein the collection enclosure includes four sides and a top, the discharge opening passing through one of the four sides, the powered vacuum unit is structurally separate from the collection enclosure, and a hose interconnects the powered vacuum unit and the discharge opening.

20. An assembly as defined in claim 17, wherein the collection enclosure includes four sides and a top, the top having at least a portion which is transparent such that bees within the collection chamber can be viewed.
